(19) United States
(12) Patent Application Publication
(10) Pub. No.: US 2010/0218958 A1
(43) Pub. Date: Sep. 2, 2010

(54) DETONATION FLAME ARRESTER

(75) Inventors: Martyn Raymond Cooling, Shropshire (GB); Daomin Hong, Manchester (GB); Graham Arthur Davies, Macclesfield (GB)

Correspondence Address: BASCH & NICKERSON LLP, 1777 PENFIELD ROAD, PENFIELD, NY, 14526, US

(73) Assignee: Knitmesh Limited, Flintshire, North Wales (GB)

(21) Appl. No.: 11/912,072

(22) PCT Filed: Apr. 21, 2006
(86) PCT No.: PCT/GB06/01463

§ 371 Date: Oct. 10, 2008

(30) Foreign Application Priority Data
Apr. 21, 2005 (GB) 0508096.5

(51) Int. Cl. A62C 4/02

(52) U.S. Cl. 169/45; 169/54

(57) ABSTRACT

A detonation flame arrester (10) in a gas pipeline (11), comprises a detonation arresting element (12) and a separate deflagration arresting element (23), the detonation arresting element comprising parallel channels having a typical transverse dimension of the same order of magnitude as the detonation cell width of the gas in the pipeline. The walls of the channels are of non-porous material so that the channels are not connected. The elements (12, 23) may be spaced apart or in contact. The elements may be located in an expanded section (17) of the pipeline, or in the pipeline itself.

The present invention relates to detonation flame arresters that arrest all kinds of explosions, including deflagration, stable detonation, and unstable (or overdriven) detonation.

Flame arresters are devices to allow flow but prevent flames propagating in gas pipelines and associated equipment. Flame arresters are broadly divided into two major types: deflagration arresters and detonation arresters.

Gas explosions are characterised principally in terms of two types according to the mechanism of combustion:
Deflagrations—where the combustion rate is controlled by the supply of oxygen to the explosion front which travels at subsonic velocities in the unburnt gas. The propagation mechanism is a heat transfer effect. In deflagrations, the combustion reactions are strongly dependent on heat and mass diffusion in the region of energy release.
Detonations—where the combustion is initiated by the pressures and temperatures associated with the shock wave, which travels at supersonic velocities in the reactants. Propagation is due to compression effects (by shock compressive heating of the unreacted gases ahead of the propagation front). Detonations generate high pressures and are usually much more destructive than deflagrations.

Detonations can be further subdivided into two types:
1. Stable detonations, which occur when the detonation progresses through a confined system without significant variation of velocity and pressure characteristics; and
2. Unstable detonations, which occur during the transition of a combustion process from a deflagration into a stable detonation. The transition occurs in a limited spatial zone where the velocity of the combustion wave is not constant and where the explosion pressure is significantly higher than that in a stable detonation.

Accordingly, there are three different types of flame arresters according to the hazards and applications:
1. Deflagration flame arrester: designed and tested to stop deflagrations;
2. Stable detonation arrester: designed and tested to stop stable detonations and deflagrations;
3. Detonation flame arrester: designed and tested to stop deflagrations, stable detonations and unstable (overdriven) detonations.

Because of these high pressures and velocities of the detonation waves, the apparatus used for quenching a deflagration will not be suitable for attenuating a shock wave, the control of which requires special equipment. The present invention applies to detonation arresters.

Arresters need to be of robust construction to withstand the mechanical effects of detonation shock waves while quenching flame in an inhospitable operating environment. Conventional detonation flame arresters normally contain a porous medium, typically a matrix of separate parallel channels, which absorbs the energy of the shock wave and removes the heat from the flame.

Such devices typically use a porous single medium which results in arresters which are large, heavy and expensive and which introduce a relatively high resistance to the flow of gas.

In order for a flame arrester to achieve its intended function, it is conventional to pass the flammable gas mixture through a porous medium which is selected according to the following objectives:
1. To prevent the transmission of flame from the unprotected side of the device to the protected side—for both deflagration and detonation devices.
2. To minimise the resistance to flow under the normal operating process conditions (i.e. low pressure drop across the device)—for both deflagration and detonation devices.
3. To attenuate the shock wave associated with detonations—for detonation devices.

Existing detonation arresters available in the field generally make use of a single form of the porous medium to satisfy all three objectives described above. The majority of devices employ an arresting element constructed from this porous medium which is housed in a section of pipework made up of an expansion section and a reduction section.

The main reason for the expansion and reduction sections is to reduce the resistance to flow through the element during normal operation and to weaken the detonation wave through the shock wave rarefaction in the case of an event. It is conventional to design arresters in which the ratio of the element diameter to the pipe diameter lies in the range 2 to 4, with the majority of devices having a ratio of approximately 2.

As mentioned above, most devices available in the field have elements which are constructed from a single style of porous medium. In a large majority of these devices, this medium is known as “crimped ribbon” which is formed by spirally winding a layer of flat metal foil between layers of foil which have been crimped. The crimped ribbon element contains many non-connected channels in the direction of flow, with each channel being roughly triangular in cross section.

The characteristic dimension of the triangular aperture (cell size) varies depending on the composition of the gas stream and the properties of the system, especially pressure and temperature. Typically the cell size is established through testing under explosion conditions and is of the same order of magnitude as the maximum experimental safe gap (MESG) for the gas mixture or less. In practice, the characteristic transverse dimension, or cell size, does not exceed 0.5 mm.

For the purposes of specifying an arrester for a particular duty, it is convenient to group gases according to their MESG. By way of example, the gas groups identified in EN 12874:2001 for deflagration and detonation tests are tabulated in Table 1 along with nominal MESG values.

TABLE 1
Specification of gas/air-mixtures for deflagration and detonation tests.

| | | Test Composition | Nominal MESG |
|---|---|---|---|
| Gas Group | Reference Gas | (% v/v fuel in air) | (mm) |
| IIA | Propane | 4.2 ± 0.2 | 0.94 |
| IIB1 | Ethylene | 5.0 ± 0.1 | 0.83 |
| IIB2 | Ethylene | 5.5 ± 0.1 | 0.73 |
| IIB3 | Ethylene | 6.5 ± 0.5 | 0.67 |
| IIB | Hydrogen | 45.0 ± 0.5 | 0.48 |
| IIC | Hydrogen | 28.5 ± 2.0 | 0.31 |

In addition to crimped ribbon, a wide variety of other forms of material have been used to attenuate detonations and prevent flame passage. Some examples of these include:
1. packed beds (e.g. metal spheres, ceramic spheres, sand/rock beds)
2. wire mesh (e.g. woven mesh or knitted mesh packings)
3. plates (e.g. parallel plates)
4. rods and cylinders
5. sintered metals
6. foams (e.g. reticulated metal foams)
7. expanded metals (e.g. in cartridge form)
8. perforated plates
9. hydraulic (liquid seal arresters) (e.g. water quench devices)

Deflagration and detonation arresters also have other features which are used to categorise them according to the duty they are to perform:
1. In-line or end-of-line: a deflagration arrester may be designed to suit an in-line or end-of-line application, whereas detonation arresters are always in-line devices.
2. Endurance burn: an arrester may be designed to operate under conditions where a flame becomes stabilised in the piping system. The device must be designed to prevent flashback of the flame to the protected side, and the unit is categorised as short time burning or endurance burning according to the length of time that such flashback can be prevented.
3. A device may be uni-directional or bi-directional. In the former case, it is essential to fit the unit carefully to ensure that it functions properly in the case of an event.

There are various problems associated with the design of these prior art detonation and deflagration arresters. For example, the reliance of current designs on the importance of MESG to determine aperture sizes combined with the practice of using single medium forms for the arrester element results in high pressure losses and in arresters which are large/heavy and which subsequently have a high cost.

Furthermore, the preference for crimped ribbon elements as the basis for the porous medium limits the elements to a circular shape, which may not always be desirable, particularly when fitting these devices in pre-volume applications (e.g. in vacuum pumps etc).

Prediction of the deflagration to detonation transition (DDT) is not amenable to exact scientific analysis. As well as the gas composition and the system properties, the onset of DDT can be triggered by factors such as the piping geometry, the presence of intrusion into the pipework (e.g. gaskets, instrumentation etc) and other factors such as surface roughness and the presence of liquids (e.g. from condensation).

There is also some anecdotal evidence that under certain circumstances a unit designed for stopping fast deflagrations or stable detonations may allow slow deflagrations to transmit through the porous media.

These factors introduce a potential safety concern in that the large size and high costs of devices suitable for unstable detonations give rise to a preference to specify the lighter and cheaper deflagration arresters.

Although these devices are specified with limited run-up distances (i.e. the distance between potential ignition source and the arrester), L/D=50 for hydrocarbon systems and L/D=30 for Group TIC (hydrogen) systems, where L is the run-up distance, and D is the nominal bore size of the arrester, the devices are often inaccessible for maintenance purposes.

There is also the danger that changes in process conditions and/or layout may render the device ineffective and there is a real risk of misapplication of these devices.

Aspects of the present invention seek to overcome or reduce one or more of the above problems.

The detonation flame arrester disclosed in US patent application 2003/0044740 comprises a flame-extinguishing element in the form of a canister with cylindrical wire screen walls containing a particular fill medium. A shock wave is absorbed by causing it to strike a solid domed end of the canister and to be deflected into a side chamber surrounding the canister. This requires a construction which has a considerably greater cross section than the associated gas pipeline. Also, reflection of shock waves from solid surfaces can be problematical.

There have been several proposals to counter detonations in gas-pipes which involve the lining of tubular walls with porous acoustically-absorbent materials. One example is the article by Evans M. W., Given F. I., and Richeson W. E., “Effects of Attenuating Materials on Detonation Induction Distances in Gases”, J. App. Phys., 26(9), 1111-1113 (1955).

Other proposals are disclosed in U.S. Pat. No. 4,975,098 (Lee and Strehlow). Low pressure drop detonation arrester arrangements for pipes are provided in which the walls of the pipe are lined with an acoustically absorbent material, such as a porous material or a wire mesh. Alternatively, a plurality of axially extending channels are provided within the pipe, the walls of each channel being lined with the acoustically absorbent material. The absorbent section is arranged between and spaced apart from two flame arresters. The length of the absorbent section is a multiple, typically 6, of the pipe diameter. In practice the arrangement due to the role played by an acoustically absorbent material or a wire mesh screen has been found to be limited to an initial system pressure of 200 mbara.

From the article “The Failure Mechanism of Gaseous Detonations: Experiments in Porous Wall Tubes,” Radulescu M. I., and Lee J. H. S., Combustion and Flame 131: 29-46 (2002), one of the authors of which is an inventor of U.S. Pat. No. 4,975,098, it is clear that such porous wall structures can only be used at relatively low initial pressures (between 2.2 and 42 kPa). A range of initial pressures up to 50.7 kPa is disclosed in the article “Experimental study of gaseous detonation propagation over acoustically absorbing walls” Guo C., Thomas G., Li J., and Zhang D., Shock Waves 11: 353-359 (2002). Evans et al. (1955) only found that the onset of detonation was delayed due to acoustic absorbing wall materials. In fact, experiments have shown that the re-intension or re-initiation process of detonation waves occurs downstream of the acoustic absorbing walled section in the pipe, including the onset of an overdriven detonation at some distance away from the exit of the acoustically absorbent section.

Aspects of the present invention seek to provide an improved arresting arrangement which separates the functions of attenuating the shock wave associated with a detonation or DDT event from quenching flame/deflagration.

Other aspects of the present invention seek to provide a detonation flame arrester which can operate at relatively high initial pressures and can withstand high detonation pressures and velocities.

Further aspects of the present invention seek to provide a detonation flame arrester which is substantially shorter than existing arresters especially with larger nominal pipe diameters.

Aspects of the invention seek to provide a detonation flame arrester which does not require an expanded section, i.e. a section of larger diameter than the rest of a pipeline in which it is disposed.

According to a first aspect of the present invention, there is provided a detonation flame arrester comprising at least one detonation arresting element and at least one serially-disposed deflagration arresting element, the detonation arresting element comprising a plurality of generally parallel channels, characterised in that said channels are not interconnected and in that each channel has a characteristic transverse dimension of 0.95 mm or greater.

The characteristic transverse dimension can be the cross-sectional size of a passageway through a tube for example. It can be the equivalent circular diameter or the hydraulic diameter, or the pore dimension.

Advantages of the arrester are that it serves to isolate detonation in the gas and efficiently removes heat from the flame front.

Preferably at least the internal walls of each channel are substantially smooth. It is believed that the smooth nature of the walls will cause less compression effects on gas (i.e., with less energy density) and thus improve the attenuation performance. On the other hand, the severely pre-compressed gas due to porous walls is more susceptible to re-initiation of a detonation. Recent work, “Hydraulic Resistance as a Mechanism for Deflagration-to-Detonation Transition,” Brailovsky I., and Sivashinsky G. I., Combustion and Flame 122: 492-499 (2000), shows that the hydraulic resistance exerted by a porous matrix or a rough tube could trigger DDT.

In preferred arrangements the length of the detonation arresting element is substantially greater than that of the deflagration arresting element. In preferred arrangements the factor is at least two, and in some preferred arrangements the factor is at least ten. In general the length of the detonation arresting element is adjustable to optimised dimensions for the length if the deflagration arresting element. Because of the relatively small length of the deflagration element, it does not produce a high pressure drop despite its smaller apertures. For similar reasons, an advantageous arrangement is obtained in an arrester comprising a deflagration arresting element disposed between two detonation arresting elements. Such an arrester has the particular advantage of providing a compact, all-purpose arrester in a single unit which can be used in different applications for different gases. Because it can be produced in large quantities to benefit from the economy of scale, it can still be specified in many locations, even if its performance is higher than required, as it provides an additional safety factor.

According to a second aspect of the present invention, there is provided a detonation flame arrester comprising at least one detonation arresting element and at least one serially-disposed deflagration arresting element, the detonation arresting element comprising a plurality of generally parallel channels, characterised in that the walls of said channels are non-porous and in that each channel has a characteristic transverse dimension of 0.95 mm or greater. Such non-porous walls are solid and impermeable to gases.

According to a third aspect of the present invention, there is provided a detonation flame arrester comprising at least one detonation arresting element and at least one serially-disposed deflagration arresting element, the detonation arresting element comprising a plurality of generally parallel channels, characterised in that the walls of said channels are of an acoustically reflective material and in that each channel has a characteristic transverse dimension of 0.95 mm or greater.

According to a fourth aspect of the present invention, there is provided a detonation arrester comprising a plurality of generally parallel channels, characterised in that said channels are not interconnected and in that each channel has a characteristic transverse dimension of 0.95 mm or greater.

Such an arrester is suitable for retro-fitting in a situation where a deflagration arrester element is already installed.

According to a fifth aspect of the present invention, there is provided a method of suppressing detonations in a gas comprising providing at least one deflagration arresting element and at least one detonation arresting element comprising a plurality of generally parallel channels, characterized in that each channel has a characteristic transverse dimension of between MESG and s (or s/π), where “s” is the detonation cell width of the gas. The gas is usually a mixture of individual gases. Preferably the characteristic transverse dimension is s/(4π). Generally speaking, the value should be s/π but s/2 for H₂. The value of s/(4π) used here is due to a safety factor and allows one to develop a shorter detonation arresting element, which reduces the overall size and weight of the device.

The length of the detonation arresting element in preferred embodiments is at least ten times the length of the deflagration arresting element, especially if the deflagration arresting element is of sintered gauze laminate. However, similar length detonation arresting elements, but at least twice the length of the deflagration arresting element, may be employed, especially when the deflagration arresting element consists of crimped ribbon.

In one preferred embodiment, some or all of the elements are arranged in a radially enlarged portion of a pipeline. Such an arrangement reduces the pressure drop in the pipeline.

In another embodiment, all of the components are arranged in a part of the pipeline which has the same diameter as the adjacent pipeline. Such an arrangement can save space around the pipeline, avoid the need to introduce bends in the pipeline, and facilitate retrofitting in suitable circumstances.

Preferred embodiments of the present invention will now be described, by way of example only, with reference to the accompanying drawings, of which:

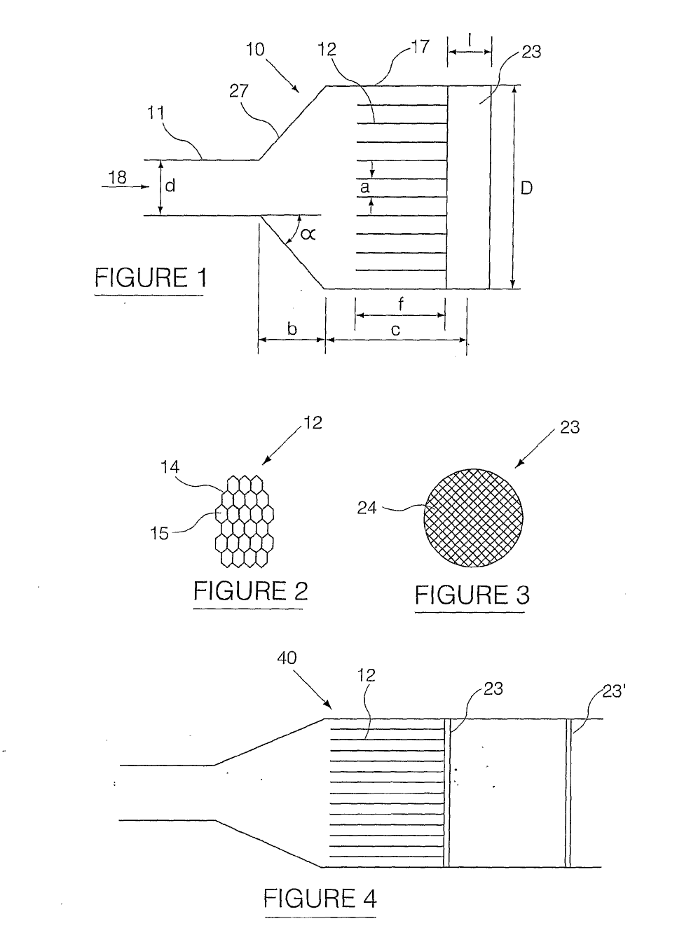

FIG. 1 is a schematic side view of an arrester in accordance with a first embodiment of the present invention;

FIG. 2 is a cross-sectional view of part of a first arrester component (i.e. a detonation arresting element);

FIG. 3 is a cross-sectional view of part of a second arrester component (i.e. a deflagration arresting element);

FIGS. 4-7 are schematic sectional side views of second, third, fourth and fifth embodiments, respectively, of the present invention;

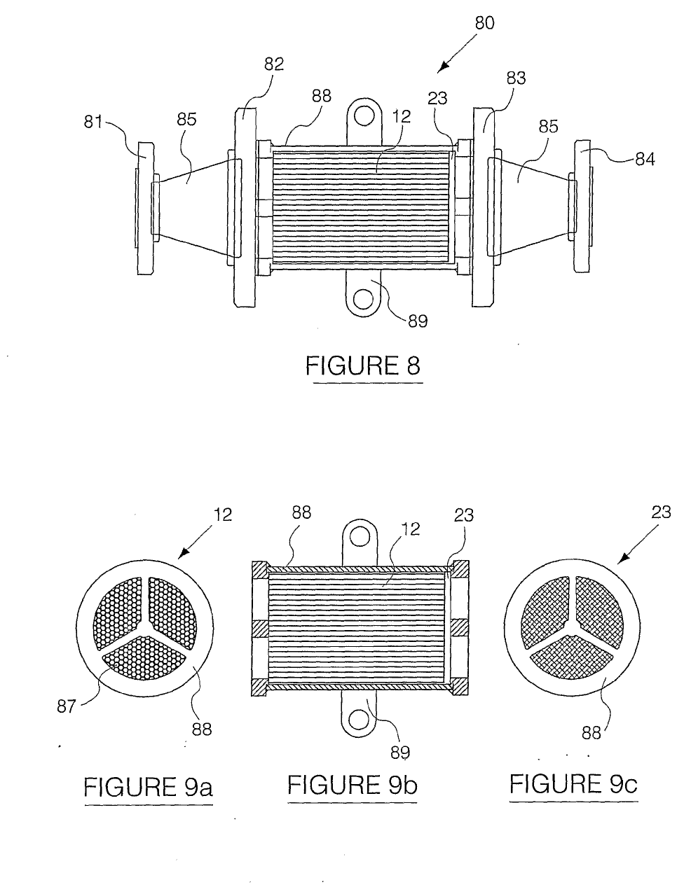

FIG. 8 is a side sectional view of an arrester in accordance with a sixth embodiment of the present invention;

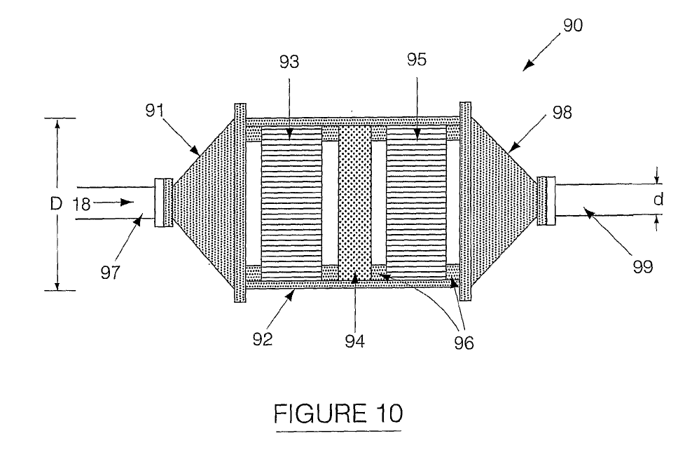

FIG. 9a is a left-hand end view of the main section of the arrester of FIG. 8 showing a first component thereof;

FIG. 9b is a side sectional view of the main section of the arrester of FIG. 8;

FIG. 9c is a right-hand end view of the main section of the arrester of FIG. 8 showing a second component thereof; and

FIG. 10 is a side sectional view of an arrester in accordance with a seventh embodiment of the present invention.

Referring to the drawings, FIG. 1 shows a detonation flame arrester 10 in accordance with a first embodiment. The arrester is connected in series between adjacent lengths of a gas pipeline 11 having a diameter ‘d’. The arrester is located in a widened section 17 of the pipeline having a diameter D which is typically twice ‘d’. Section 17 is connected to each adjacent length of pipeline by means of a respective tapering portion 27 of axial length b and defining an angle of relative to the axial direction. An angle equal to 90° would correspond to a perpendicular step in the pipeline wall. The arrester comprises a first component 12 comprising a matrix of non-connected tubular passages 14. A cross section of these passages 15 is shown in FIG. 2. In the example the passages 14 are shown to tessellate the cross section. The apertures of the array of tubes are larger than those used in conventional flame arresters. The length “f” of the first component is of the order of 10 cm. Component 12 serves to damp shock waves associated with detonations travelling down pipeline 11.

Located immediately downstream of component 12 of the direction of gas flow indicated by arrow 18 is a second component 23. The porous medium 24 of component 23 may take the form of a matrix of tortuous connected pathways or non-connected pathways, as shown in FIG. 3. The effective diameters of these pores are typically in the range 0.10-0.15 mm and may be similar to those used in deflagration flame arresters. The length 1 of the second component is typically 6 mm; note that FIG. 1 is not drawn to scale. Component 23 serves to quench flames travelling from component 12.

The combined length of components 12 and 23 can be contrasted with the length of a corresponding single conventional component (used to arrest both detonation and deflagration) of 8˜10 cm, usually in the order of 10 cm. Thus component 12 is longer than or similar to the corresponding conventional component, but component 23 is much shorter.

When designing a particular arrester 10, the characteristic transverse dimension “a” of the tubes 15 (corresponding to the diameter of a circular tube) is selected so that a detonation cannot propagate therethrough. It depends on a number of factors, including the nature of the gas system in pipeline 11, the gas velocity and the gas pressure and should also include a safety margin. For stoichiometric fuel-air mixtures at atmospheric pressure, there is a minimum transverse detonation cell size “s” of the explosive mixture, see Table 2. For circular tubes, the tube diameter below which a detonation cannot propagate in the pipe is typically between s divided by 2 and s divided by π. Theoretically, the onset of single headed spin detonation represents the limiting condition and this corresponds to a situation with a tube diameter corresponding to a half detonation cell width, s/2. In practice, the value of “a” may be chosen in the range between the MESG and s (or s/2) but is subjected to optimisation.

Some data for four typical gases in air are shown in Table 2, with the gases ranked in order of increasing difficulty with respect to attenuating the shock wave. One example of the dimension “a” is shown in Table 2 for each gas in air. The dimension “a” is a significant parameter and has an upper limit of s. “f” is dependent on “a”.

TABLE 2
(All Dimensions in mm)

| | | Ethylene | | Acetylene |
|---|---|---|---|---|
| Chemical | Propane | (Ethene) | Hydrogen | (Ethyne) |
| Detonation Cell Size (s) | 69 | 28 | 15 | 9.8 |
| Limiting Tube Diameter | 23 | 12 | 5 | 4.6 |
| L.T.D. with Safety Margin | 7.95 | 3.1 | 1.6 | 1.5 |
| (a) | | | | |
| Length (f) | 424 | 131 | 56 | 54 |
| Dimension b | 2d | 2d | 2d | 2d |
| Dimension c | (1-3) d | (1-3) d | (1-3) d | (1-3) d |

The length “f” of component 12 should be sufficiently large to dissipate the shock wave before the porous medium 23. One example of “f” is shown in Table 2 for each gas. For smaller values of “a”, a shorter length “f” is required to attenuate a shock wave.

The value of the length “f” is, in principle, independent of the arrester size (represented by the nominal bore of the pipe connection ‘d’). Therefore, for larger arresters the overall dimensions of the new design will be smaller than for conventional units as the length of these tends to increase as ‘d’ increases.

Examples, in terms of the diameter ‘d’ of the pipeline, are given in Table 2 for the length ‘b’ of the tapering section 27 and the distance ‘c’ between the wider end of section 27 and the centre line of the second component 23. In preferred embodiments, tubes 15 have a wall thickness in the range of 0.05 to 0.75 mm, most preferably 0.10 to 0.25 mm.

The above dimensions give only a general indication based on various assumptions, e.g. a gas pipeline 11 with a diameter lying within the range of 5 cm to 15 cm and a flame velocity leaving the porous medium 12 of 500˜800 m/s. Due to the uncertainty of the viscosity of the gas in the combustion zone at the outer edge of the boundary layer, various dimensions and especially damping length “f” should be determined by experiments. In actual applications, dimensions “a” and “f” should be optimised to increase the quenching efficiency and make the device more compact.

One example, where the gas is ethylene in air, has the following features:
a=5 mm
f=240 mm
wall thickness=0.0762 mm

component 23 is sintered gauze laminate or crimped metal ribbon.

Another example for ethylene in air has the following features:
a=2 mm
f=80 mm

component 23 is sintered gauze laminate or crimped metal ribbon.

In use of the arrester 10, a detonation-produced pressure or shock wave travelling in the direction of arrow 18 encounters first component 12. In view of the above-described parameters, this prevents the detonation from reaching the second component 23. Only the deflagration reaction front reaches the second component 23, and is extinguished in the medium.

Arresters according to the present invention can be used for gas-air and gas-oxygen mixtures.

The above-described arrester has a number of advantages. Firstly, the flow resistance across the composite system is less than that of a conventional detonation flame arrester containing porous media. This is based on the realisation that there is no need to be restricted by reliance on MESG criteria for detonation. Thus there is a smaller pressure drop across the device. At first glance, this use of wider apertures appears to be counter-intuitive but is backed by detonation physics indeed.

As a result the arrester 10 has a certain degree of design freedom, in that the diameter D of section 17 can be reduced since there is less of a pressure drop to be compensated and detonation waves can be attenuated by component 12.

Another advantage is that the weight and cost of the composite media is less than that normally used in conventional arresters. On large systems, this has a significant advantage for installations at elevated positions.

Tests have shown that the above arresters in accordance with the present invention can operate at substantially higher initial pressures (e.g. up to 1.6 bara) compared to the arrester disclosed in U.S. Pat. No. 4,975,098 (Lee and Strehlow). The theoretical basis that underpins the invention described in the patent of Lee and Strehlow is not well defined. In one embodiment of the patent they describe a configuration in which “the absorbent may be disposed in a porous walled tube bundle arrangement which is inserted in the pipe such that the axes of the tubes are parallel to the centre of the pipe.” In this arrangement it is believed that the porous nature of the channel walls allows gas to flow through the walls of adjacent channels and thereby alters the dynamics of the detonations, including detonation interactions between adjacent channels. On the other hand, since the channel walls of embodiments in accordance with the present invention do not have connections between the channels, such linkage is prevented. In addition the channel walls of preferred embodiments are substantially smooth and it is believed that the gas in the channels is less compressed (i.e. with lower energy density) and thus less susceptible to re-initiation of the detonation.

In another embodiment of their invention, Lee and Strehlow describe an arrangement in which the walls of the pipe are lined with an acoustically absorbent material. The walls are impermeable and therefore the mechanism described above cannot apply to this case. The mechanism on which this embodiment of their invention may rely is attenuation of the transverse waves in or by the acoustically absorbent material. However, in more recent work according to Radulescu and Lee (2002), “conclusive proof of the important role of the transverse waves on the propagation mechanism of detonations is still lacking”. The paper also indicates that for the system with a regular cellular structure with weaker transverse waves, the detonation transverse waves do not play a significant role in detonation propagation mechanism, i.e., attenuation of the transverse waves does not always play a significant role in failure mechanism of gaseous detonations. More significantly and importantly, experiments including Lee's work show that rapid attenuation of the detonation waves due to acoustically absorbent porous walls is limited to relatively low initial pressures. On the other hand, at higher initial pressures, the porous walled tubes can cause much higher hydraulic resistance and more severe pre-compression effects on gas. The re-initiation detonation lengths decrease with the increase of the initial pressure. Furthermore, the distance 2D required by Lee and Strehlow is not allowed in embodiments of the present invention because this distance will cause re-generation of detonation upon exiting the damping section and the initial C-J detonation velocity will be recovered.

Various modifications may be made to the previously-described arrangements. The cross-sections of the tubes or passageways within component 12 may have any desired shape, in particular exact or approximate triangles, squares, rectangular parallelograms, honeycombs, other polygons, circles or other curved outlines.

Besides crimped ribbon or sintered gauze laminate, the passageways within component 23 can be of knitted mesh, enclosed tubes, randomly packed particles of a fill medium, solid rod elements with passageways therebetween, or parallel plate elements with slits there between. A metal foam member can be used to provide an additional heat transfer surface to deal with deflagration.

Since component 12 is required only to attenuate shock waves and quench the detonation, it can be made of materials other than steel, the design of which must be able to withstand the radial compressive load resulting from the shock wave. Alternative materials may include other metals and alloys, carbon and other composites, polymers and other plastics, glass and ceramics. This enables weight and cost to be saved, particularly as this is the larger of the two components.

These materials are provided in solid wall form, but the surface may be treated with coatings of various forms to provide resistance to chemical attack and withstand mechanical loading due to shock wave and also to provide optimal surface conditions.

In addition, the component may be formed using any of the following manufacturing processes: fabrication (e.g. formed, welded, pressed, extruded), casting, or moulding.

In alternative or additional modifications of the detonation arresting component 12, the detonation arresting element can be formed by two or more parts, each having same or different apertures, and some or all of the channels may be inclined to the central longitudinal axis of the arrester. Furthermore, the apertures within a single part may vary in size and/or shape, based for example on a specified distribution over the component's surface.

To protect the front of component 12 from damage by the direct impact of a shock wave, it can be provided with a thin piece of crimped metal ribbon, perforated plate, wire grid or wire mesh.

Four prototype 50 mm nominal bore unstable detonation arresters have been tested. These prototype devices were of different configurations with different combinations of elements, in which detonation attenuation elements had different apertures and damping lengths (of honeycomb cores). In general, the testing results demonstrated that the detonation waves were effectively attenuated by the detonation arresting elements and indeed became deflagration.

Both detonation arresters, bi-directional and uni-directional, have been successfully tested to stop flame transmission into the protected side for gas group IIB3 (6.5% ethylene and air) at the initial pressures of 1.25 bara and 1.4 bara, respectively, with the framework of the test protocol of European Standard EN 12874:2001 for unstable detonation arresters.

In tests, the bi-directional arrester according to the present invention, as shown in FIG. 10 which comprises detonation arresting elements of honeycomb cores and a deflagration arresting element of sintered gauze laminate, successfully prevented flame transmission into the protected side in any deflagration and unstable detonation tests for gas group IIB3 (6.5% ethylene and air) at the initial pressures of 1.25 bara.

On the other hand, the detonation arrester significantly reduces the pressure drops over the arrester, that is, it demonstrates much lower pressure drops than a conventional detonation arrester and so is suitable for extensive applications in the chemical, petrochemical, energy transportation and pipeline industries.

It is worth mentioning here a phenomenon known as “pressure piling”. As a shock (or combustion) wave travels down a pipe in which there is a flow restriction (such as a flame arrester), the unburned gas immediately upstream of the restriction is subjected to increased pressure. So, although the system pressure in the pipe immediately prior to ignition may be slightly more than atmospheric pressure (e.g. 1.4 bara), the pressure of the gas immediately prior to detonation may be several times higher than this (e.g. ˜5 bar). The amount of energy released during the detonation is related to the gas pressure, and further this relationship is not linear. So the force of the shock wave can be very significantly higher at the arrester inlet if the effect of pressure piling is significant, and could cause the arrester to transmit a flame resulting in catastrophe. Accordingly, it is a significant benefit to have a device in which the pressure drop across the unit is as small as possible to minimise the effect of the pressure piling. This is achieved in the present invention by means of the larger aperture channels used to attenuate the detonation and the relatively low flow resistance associated with the deflagration element when compared with conventional devices.

The construction of the arrester is flexible and it may be designed to suit duties with any gas group—data on the detonation cell width is well documented for all the principal gases. The construction opens up the possibility of designing an “all-purpose” arrester for each gas group identified in EN 12874. This results in a single product for each gas group to deal with unstable and stable detonations and also deflagrations instead of the three separate products that exist for such duties.

The design may be adapted to pre-volume applications—i.e. it is not limited only to circular pipework systems. The arrester may be constructed of materials that enable it to be used in corrosive environments. It is easier to clean and cheaper to maintain, and the manufacturing process is simpler and manufacturing tolerances are less problematic in terms of process control. In addition the arrester may be retrofitted to existing deflagration arresters.

If desired, components 12 and 23 within section 17 need not be in intimate contact. The spacer between components 12 and 23 may be wire gauze, wire grids, or wire meshes or any other types of supporting ring/bar.

More than one type of first and/or second component may be provided. In the arrester 40 of FIG. 4, for example, another second component 23′ is located downstream of, and spaced from component 23. This provides an additional safety factor.

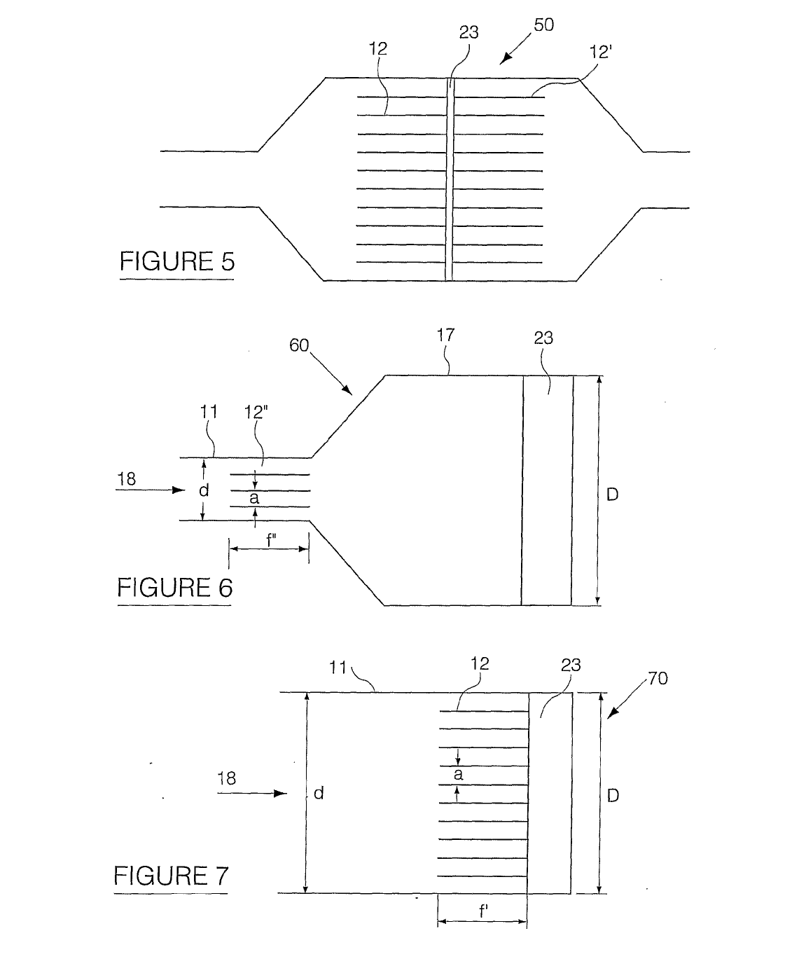

In the arrester 50 of FIG. 5, a single component 23 is sandwiched between two first components 12, 12′. This forms a bi-directional arrester which can handle gas flows, and explosions, in either direction. In a modification, one or both components 12, 12′ may be spaced from component 23 if desired. In another modification additional component pairs may be added to the sandwich.

In the arrester 60 of FIG. 6, the first component 12″ is arranged in a section of pipeline 11 of the nominal pipe diameter d, with the flame-quenching component 23 remaining in widened section 17. The dimension “a” and the length “f” are determined according to the same criteria as for the embodiment of FIG. 1. Component 12″ may partly extend into the widened section 17.

In the arrester 70 of FIG. 7, the widened section 17 is dispensed with completely and both components 12 and 23 are provided in a section of pipeline 11 or nominal diameter. This corresponds to an angle α (in FIG. 1) equal to zero. The dimension “a” and the length “f” are again determined according to the same criteria as for the embodiment of FIG. 1. An advantage of this embodiment is that no alteration of the diameter of pipeline 11 is necessary, which means that no extra space is required. This allows the arrester 70 to be readily retro-fitted to an existing pipeline if required.

A sixth embodiment of the present invention is shown to scale in FIGS. 8 and 9. An arrester 80 comprises a first component 12 and a second component 23 arranged to be connected to a pipeline 11 by flange members 81 to 84 and tapering sections 85. The individual tubes 87 of component 12 have an outside diameter of 6 mm and an inside diameter of 5 mm. The components 12 and 23 are located directly adjacent to each other within a housing 88, having fixing tabs 89.

A seventh embodiment of the present invention is shown in FIG. 10. An arrester 90 located in a gas flow 18 comprises an expansion section 91 the purpose of which is to allow the arrester element to have a diameter (D) which is larger than the inlet pipe 97 of diameter (d) to which it is attached. This allows the pressure drop across the system to be reduced to acceptable levels. The arrester further comprises an element housing 92, which is effectively a straight length of pipe, containing a first detonation wave attenuation element 93 designed to modulate the shock and reduce the flame speed from supersonic velocities to subsonic velocities before it enters the deflagration element. The arrester further comprises a deflagration arrester element 94 which is designed to prevent flame transmission by means of heat transfer from the flame front to the quenching element and support structure or by removing reactive intermediates (e.g. radicals) to prevent the chemical reaction propagating down to the pipe thereby extinguishing the flame. There is further provided a second detonation wave attenuation device 95 of the same (or different) construction as element 93 to form a bi-directional arrester.

Support rings or bars 96 are constructed from a material sufficiently strong to withstand the pressure wave loading associated with the flame front/shock wave.

A reducing section 98 is designed to connect the element to the outlet pipe/flange 99. The various components are held in place by a housing 92.

An arrester based on FIG. 10 has successfully passed the flame transmission tests under unstable detonation and deflagration conditions. The embodiment of FIG. 10 may be modified in various ways.

The element diameter to pipe diameter ratio (D/d) may take any value, including the “ideal” case where it has the value of unity. This can be achieved because element 93 can effectively attenuate the detonation waves and further because of the preferential pressure drops that can be achieved across this device compared with other products available in the field.

In the case where the element has the same diameter as the pipework system, there is no need for the expansion and reduction sections 91 and 98. These assemblies may be replaced by a single flange suitable for the design pressure in the pipework itself.

The device as described is bi-directional but may be made a uni-directional arrester simply by removing the second attenuation element 95 and one set of support bars 96. This has the advantage of reducing size, weight, cost and pressure drop through the finished unit. It does however require the direction of gas flow to be clearly marked on the unit to avoid human errors in installation.

The shock wave attenuation devices 93 and 95 can be used in conjunction with one or more deflagration elements 94 constructed from a wide range of materials including
sintered gauze laminate
crimped metal ribbon
sintered metal packings
packed beds of various materials
woven mesh/wire gauze/gauze layers
knitted mesh packings
metal foams
metal shot
ceramic packings, and/or
plate packs (parallel plate and perforated plate).

The support bars serve as spacing elements. They may be made of wire gauzes, wire grids, wire meshes or other suitable material.

The support bars 96 may be varied in thickness to adjust the gaps between the different elements and may be reduced to zero in the case where the element faces are in contact with each other. It is important to size the gaps in such a way as to avoid acceleration of the flame front back up to detonation conditions while to make use of the turbulent effect on increasing the heat transfer efficiency.

The arrester assembly need not be in a straight pipe. The elements may be assembled in such a way as to allow for the outlet pipe to be in a different spatial orientation to the inlet (i.e. eccentric expansion and/or reducer sections, or right angled bend in the arrester etc). The pipe work need not be cylindrical. It is possible to design the system for other cross sectional forms such as rectangular ducts or even irregular voids (e.g. for pre-volume applications such as pumps).

It is possible to design the device such that the shock wave attenuation elements 93 and 95 are situated in a length of pipe of the same diameter as the system pipe, but the deflagration element 94 is housed in an expanded section of pipe (may or may not be located in the middle of the housing). This may be an advantage in controlling pressure drop within acceptable levels, while serving to reduce weight and cut costs especially for large size arresters.

A uni-directional device constructed without the second attenuation element 95 or the deflagration element 94 may be used to convert an existing deflagration element into a detonation device. This may be achieved simply by fitting the arrester on the unprotected side of an in-line deflagration arrester for example.

The device may also be enhanced by combining this general assembly with other detonation modulators and/or deflection plates etc.

As the weight and cost of the device is proportional to the element diameter raised to the power of two, the ability to reduce the element diameter to be the same as the pipe diameter in certain embodiments of the present invention has a significant impact on lowering weight and cost.

In prior art arrangements, the performance of either deflagration or detonation arresters depends on the properties of gas mixture (MESG) and initial pressure. In embodiments of the present invention, it is not necessary to so strictly control the apertures of detonation attenuation elements within a narrow tolerance.

The detonation attenuation element of the unit may have a flame holding capability, especially, the apertures close to the quenching diameter.

The features of the various embodiments and examples may be combined or interchanged as desired.

1-23. (canceled)

24. A detonation flame arrester comprising at least one detonation arresting element and at least one serially-disposed deflagration arresting element, the detonation arresting element comprising a plurality of generally parallel channels and the deflagration arresting element comprising a plurality of pores, wherein said channels are not interconnected and wherein each channel has a characteristic transverse dimension larger than the pores and equal to at least about 0.95 mm.

25. An arrester according to claim 24 wherein at least an internal wall of each of said detonation arresting element channels is substantially smooth.

26. An arrester according to claim 24, wherein said characteristic transverse dimension is at least about 1 mm.

27. An arrester according to claim 26, wherein said characteristic transverse dimension is at least about 1.5 mm.

28. An arrester according to claim 24, wherein the detonation arresting element is substantially longer than the deflagration arresting element.

29. An arrester according to claim 28, wherein the detonation arresting element is at least twice as long as the deflagration arresting element.

30. An arrester according to claim 28, wherein the detonation arresting element is at least about ten times the length of the deflagration arresting element.

31. An arrester according to claim 24, wherein the detonation and deflagration arresting elements are disposed directly adjacent to each other.

32. An arrester according to claim 24, wherein the detonation and deflagration arresting elements are spaced apart from one another.

33. An arrester according to claim 32 wherein the detonation and deflagration arresting elements are spaced apart by at least one support element.

34. An arrester according to claim 24 comprising a deflagration arresting element disposed between two detonation arresting elements.

35. A gas piping system, including:
a gas pipeline comprising pipe; and
a detonation flame arrester incorporated in said gas pipeline by attachment to the pipe, said detonation flame arrester comprising at least one detonation arresting element and at least one serially-disposed deflagration arresting element, the detonation arresting element comprising a plurality of generally parallel channels and the deflagration arresting element comprising a plurality of pores, wherein said channels are not interconnected and wherein each channel has a characteristic transverse dimension larger than the pores and equal to at least about 0.95 mm.

36. An arrester according to claim 35, wherein a cross-sectional area of the arrester is essentially the same as a cross-sectional area of the attached pipe.

37. A method of suppressing detonations in a gas comprising providing at least one deflagration arresting element comprising a plurality of pores, and at least one detonation arresting element comprising a plurality of generally parallel channels, wherein each channel has a characteristic transverse dimension larger than the pores and equal to or smaller than a detonation cell width of the gas mixture (s), but greater than its maximum experimental safe gap.

38. A method according to claim 37 wherein said characteristic transverse dimension is at least about s/(4π).

39. A method according to claim 37, wherein said characteristic transverse dimension is at least s/8.

40. A method according to claim 37, wherein the detonation arresting element is substantially longer than the deflagration arresting element.

41. A method according to claim 37, wherein a respective detonation arresting element is provided at each end of the deflagration arresting element.

42. An arrester according to claim 24, wherein the gas has a detonation cell width (s) and said characteristic transverse dimension is equal to or less than s but greater than a maximum experimental safe gap for the gas.

43. An arrester according to claim 42, wherein said characteristic transverse dimension is at least about s/(4π).

44. An arrester according to claim 42, wherein said characteristic dimension is at least about s/8.

45. A detonation flame arrester comprising at least one detonation arresting element and at least one serially-disposed deflagration arresting element, the detonation arresting element comprising a plurality of generally parallel channels and the deflagration arresting element comprising a plurality of pores, wherein walls of said channels are non-porous and wherein each channel has a characteristic transverse dimension larger than the pores and at least about 0.95 mm.

46. A detonation flame arrester comprising at least one detonation arresting element and at least one serially-disposed deflagration arresting element, the detonation arresting element comprising a plurality of generally parallel channels and the deflagration arresting element comprising a plurality of pores, wherein walls of said channels include an acoustically reflective material and wherein each channel has a characteristic transverse dimension larger than the pores and at least about 0.95 mm.

47. An arrester according to claim 35, wherein the arrester is incorporated in an expanded section of the gas pipeline such that a cross-sectional area of the pipeline in which the arrester is incorporated is larger than a cross-sectional area of the attached pipe.
